(19) United States
(12) Patent Application Publication
(10) Pub. No.: US 2013/0282280 A1
(43) Pub. Date: Oct. 24, 2013

(54) CONTROL MODULE FOR A ROUTE GUIDANCE SYSTEM

(71) Applicants: Kieran Patterson, Lurgen (GB); Andrew Barr, Annahilt (GB)

(72) Inventors: Kieran Patterson, Lurgen (GB); Andrew Barr, Annahilt (GB)

(73) Assignee: LIGHTSTEP TECHNOLOGIES LIMITED, Belfast (UK)

(21) Appl. No.: 13/807,822

(22) PCT Filed: Jun. 29, 2010
(86) PCT No.: PCT/EP10/03852

§ 371 Date: Jul. 10, 2013

(51) Int. Cl. G01C 21/20

(52) U.S. Cl. CPC G01C 21/206
USPC 701/533

(57) ABSTRACT

A route guidance system for guiding occupants of an enclosed space to a location, such as an exit, the system including a control module with display screen and means for displaying an image of the enclosed space on the display screen. The displayed image is a scale representation of the enclosed space, preferably a bitmap of an architectural drawing of the enclosed space. The control module includes means for enabling a user to locate computer generated icons on the display screen. The control module determines the real world location of the components represented by the icons and communicates this to the relevant system components.

### FIELD OF THE INVENTION

This invention relates to a control module for route guidance system for guiding occupants of an enclosed space, such as a building. The invention relates particularly to a portable and hand-held control module for a route guidance system for evacuating a building's occupants in an emergency.

### BACKGROUND TO THE INVENTION

International PCT patent application no. PCT/EP2009/008013 discloses a route guidance system for guiding a people through a building to a point of interest or an exit and for the general control of the flow of occupants in a building, to avoid congestion and or to assist persons in locating a desired room or object, as well as for guiding evacuation of a building in an emergency. The system comprises a plurality of intelligent nodes that are aware of their location in the building and can communicate with one another in relation to, for example, their status in the event of an emergency.

It would be desirable to provide a control module for facilitating the set up, testing and/or operation of a route guidance system such as, for example, the system disclosed in PCT/EP2009/008013.

### SUMMARY OF THE INVENTION

A first aspect of the invention provides a route guidance system for guiding occupants of an enclosed space to a location, such as an exit, said system comprising a network of nodes located at spaced locations throughout said enclosed space, at least some of said nodes being adapted to convey route guidance instruction to said occupants, each node comprising a control unit and communication means enabling the control unit to communicate with the control unit of at least one other node for passing information between adjacent nodes, wherein said system further includes a control module comprising a display screen, means for storing an image representing said enclosed space, means for displaying said stored image on said display screen, wherein said image is displayable as a scale representation of said enclosed image, said control module being arranged to display image as a scale representation of said enclosed space. Advantageously, said control module comprises means for enabling a user to locate at least one computer generated icon on said displayed image, said control module further including means for calculating, in respect of the location of said at least one icon on said displayed image, a corresponding location in said enclosed space, and means for communicating data representing said corresponding enclosed space location to at least one of said nodes.

Preferably, said image comprises a bitmap of a source image of said enclosed space. Conveniently, said source image comprises an architectural drawing of said enclosed space.

In preferred embodiments, said control module comprises means for enabling a user to locate computer generated icons on said display screen. Each icon represents a component of said route guidance system, or of a hazard detection system with which said route guidance system is associated. Said components may include one or more of: said nodes; a junction; an exit; an entry; a corridor; a co-ordinate origin; a hazard detector. The control module advantageously includes means for correlating the location of an icon on said screen with a corresponding location on said displayed image. Typically, each icon (or its associated component) is allocated a unique identifier (which typically identifies not only the specific respective component but also the type of component) by the control module, and the control module calculates respective co-ordinate data for the respective component with respect to the displayed image. Conveniently, said co-ordinate data is calculated with respect to said co-ordinate origin. The control module further includes means for communicating said co-ordinate information together with the respective unique identifier to said route guidance system.

Preferably, a respective icon is provided for each type of component. At least some of said icons are preferably renderable in a plurality of visual states. The preferred control module is arranged to receive from said route guidance system and/or said hazard detection system data indicating the status of one or more of said components in respect of which an icon is displayed on said screen. Advantageously, said control module causes the respective icon to adopt one or other of its visual states depending on said status data.

Preferably, said control module is arranged to maintain, in respect of at least some of said components in respect of which an icon is displayed on said screen, one or more user-settable parameters, wherein in response to a user setting one of said parameters, the parameter setting is communicated to the route guidance system. Conveniently, the module is arranged to expose the respective parameters to said user upon selection by said user of the respective icon.

The route guidance system may include, or be co-operable with, a hazard detection system comprising one or more hazard detectors.

A second aspect of the invention provides a control module for a route guidance system for guiding occupants of an enclosed space to a location, such as an exit, said system comprising a network of nodes located at spaced locations throughout said enclosed space, at least some of said nodes being adapted to convey route guidance instruction to said occupants, each node comprising a control unit and communication means enabling the control unit to communicate with the control unit of at least one other node for passing information between adjacent nodes, said control module comprising a display screen, means for storing an image representing said enclosed space, means for displaying said stored image on said display screen, wherein said image is displayable as a scale representation of said enclosed image, said control module being arranged to display image as a scale representation of said enclosed space. Advantageously, said control module comprises means for enabling a user to locate at least one computer generated icon on said displayed image, said control module further including means for calculating, in respect of the location of said at least one icon on said displayed image, a corresponding location in said enclosed space, and means for communicating data representing said corresponding enclosed space location to at least one of said nodes.

A third aspect of the invention provides a method of managing a route guidance system using a control module, the method comprising displaying at said control module a scale image of said enclosed space; locating one or more computer-generated icons on said displayed image; calculating, in respect of the location of said at least one icon on said displayed image, a corresponding location in said enclosed space; and communicating data representing said corresponding enclosed space location to at least one of said nodes.

From another aspect, the invention provides a route guidance system for guiding occupants of an enclosed space to a location, such as an exit, said system comprising a network of nodes located at spaced locations throughout said enclosed space, at least some of said nodes being adapted to convey route guidance instruction to said occupants, each node comprising a control unit and communication means enabling the control unit to communicate with the control unit of at least one other node for passing information between adjacent nodes, wherein said system further includes a control module comprising a display screen, means for storing an image representing said enclosed space, means for displaying said stored image on said display screen, wherein at least some of said icons are renderable in a plurality of visual states, said control module being arranged to receive from said route guidance system and/or a hazard detection system with which said route guidance system is associated, data indicating the status of one or more of said components in respect of which an icon is displayed on said screen, said control module being arranged to cause the respective icon to adopt one or other of its visual states depending on said status data. Further aspects of the invention provide a corresponding control module and corresponding method of managing a route guidance system.

A still further aspect of the invention provides a route guidance system for guiding occupants of an enclosed space to a location, such as an exit, said system comprising a network of nodes located at spaced locations throughout said enclosed space, at least some of said nodes being adapted to convey route guidance instruction to said occupants, each node comprising a control unit and communication means enabling the control unit to communicate with the control unit of at least one other node for passing information between adjacent nodes, wherein said system further includes a control module comprising a display screen, means for storing an image representing said enclosed space, means for displaying said stored image on said display screen, wherein said control module is arranged to maintain, in respect of at least some of said components in respect of which an icon is displayed on said screen, one or more user-settable parameters, wherein in response to a user setting one of said parameters, the control module is arranged to communicate said parameter setting to at least one of said nodes. Advantageously, in response to receiving a parameter setting indicating a desired status, the respective node is arranged to adopt said desired status. Further aspects of the invention provide a corresponding control module and corresponding method of managing a route guidance system.

Embodiments of the invention are particularly suitable for use with a route guidance system for guiding occupants of an enclosed space to a location, such as an exit, wherein said system comprises a network of interconnected nodes located at spaced locations throughout said enclosed space, at least some of said nodes being adapted to convey route guidance instruction to said occupants, each node comprising a control unit and a communication means enabling the control unit to communicate with the control unit of at least one adjacent node for passing information and/or instructions between adjacent nodes.

A control module embodying the invention may be said to comprise part of said route guidance system. The control module preferably comprises portable, hand held unit that is capable of communicating with said system remotely, e.g. by wireless communication means. Alternatively, or in addition, the control module includes means for establishing a hardwired connection with the system, especially the nodes, for example by means of a cable and/or connector.

Typically, the control unit of each system node is programmed to control the operation of the node as a function of information and/or instructions received from one or more adjacent nodes and/or sensors and to communicate information and/or instructions to one or more further nodes in response to said information and/or instructions received. The node control unit conveniently comprises a suitably programmed digital data processing unit or microcontroller.

Typically, said communication means between nodes comprises wireless communication means. Alternatively, or additionally, at least some of the nodes may be hardwired together.

Preferably each node is provided with a unique identifier, such as a numeric identifier or address. Said unique identifier may be communicated to other nodes along with information/instructions to enable identification of each node of the system.

One of the nodes may be designated a leader or dominant node such that the leader node can determine the operation of all remaining nodes. The nodes may be designated in a hierarchy such that one node will take control of the nodes, becoming the leader node, should the existing leader node become disabled or damaged.

Said route guidance instruction may be provided to the occupants by audible and/or visual display means.

One of more of the nodes may be provided with, or be associated, with one or more sensors for sensing environmental conditions, such as temperature and visibility/smoke, or traffic/movement of the occupants within the enclosed space, the control unit of such one or more nodes providing information to adjacent nodes based upon input from said one or more sensors. Said one or more sensors may comprise one or more of a heat sensor and/or a smoke sensor and/or an auditory sensor and/or a light sensor, the light sensor operable to generate a signal on detection of a reduced light level.

One or more of the nodes may be provided with a proximity sensor, enabling the node to determine crowding in the surrounding region and/or determining the movement of people in the region of the node. Said proximity sensor may be adapted to detect and recognise a unique identifier tag, such as an RFID tag, associated with a person or object adjacent the node, such that the node can identify the presence of said tagged person or object adjacent said node. Such arrangement may enable the network of nodes to monitor the location of said tagged person or object within said enclosed space. Such tagged person or object may comprise an emergency worker, such as a fire fighter, enabling the system to monitor the location of such tagged person within the enclosed space. The identifier tag may also provide information concerning the status or health of a person to which the tag is attached, said information being received by the node to enable the condition of a tagged person to be determined by the system.

Further preferred features are recited in the dependent claims. Other advantageous aspects of the invention will become apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1 is a perspective view of a control module embodying the invention;

FIG. 2 is a stylised schematic of a floor layout of a building in which a route guidance system is installed; and

FIG. 3 is a sample screen shot from a visual display device included in the module of FIG. 1.

### DETAILED DESCRIPTION OF THE DRAWINGS

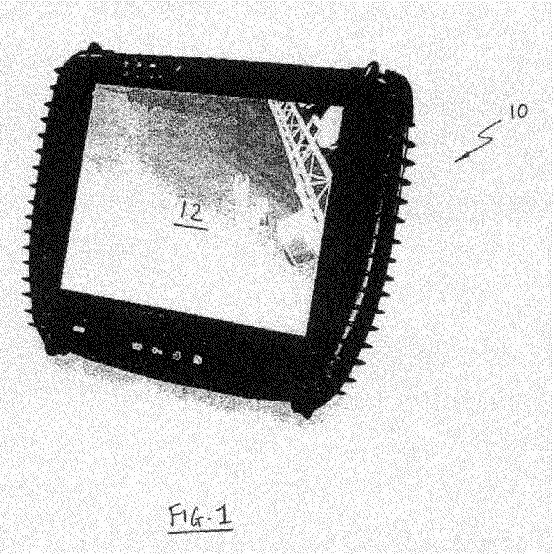

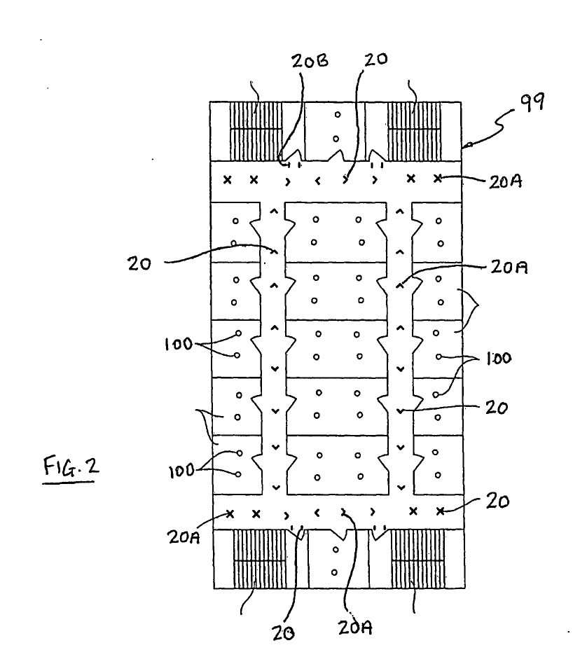

FIG. 1 shows a hand-held, portable control module 10 embodying one aspect of the invention. The control module 10 is co-operable with a route guidance and evacuation system, part of which system is illustrated by way of example in FIG. 2 installed in a building 99. In preferred embodiments, the control module 10 forms part of the route guidance system. The control module may also be co-operable with a hazard detection system installed in the building.

In preferred embodiments, the route guidance system comprises a network of individual nodes 20 that interact during use to provide a coordinated and intelligent route guidance network for implementing a strategy for safe and efficient evacuation of an enclosed space. Each individual node 20 includes with a control unit and communication means enabling the respective control unit to communicate with adjacent, or other, nodes 20, each node 20 having a unique address, or other identifier, so that it can be identified by other nodes 20 in the system. Each node 20 may also be provided with, or be in operative association with, e.g. in control of, one or more of: means for providing route guidance advice/warnings to occupants 100 of the building; means for sensing environmental parameters from the node's surroundings; means for displaying information to users; and/or means for receiving external control commands.

Individual nodes 20 of the network may be equipped to use light in one or more of a variety of ways to convey instructions about how best to escape a danger zone and how to avoid areas of congestion or other hazard in the process. To this end, each node 20 may include, or be in operative association with one or more devices for rendering a visual message to a user, e.g. a light source, a light display, a light projector, other display device e.g. screen, and/or other route guidance device. Preferred implementations include means for projecting images and/or messages onto floor areas, means for projecting or displaying focussed light beams of two different colours e.g. red or green, and illuminatable components, such as lamps, panels, icons or strips, preferably at floor or waist height where they will be of most value to an escapee in a dark and smoke filled building.

The nodes 20, and in particular the visual units with which they are associated, may be embodied in a number of different forms. For example, in FIG. 2, nodes 20A take the form of floor tiles that are operable to display a first image, e.g. an X, to indicate that a person should not proceed in the direction of the floor tile, or a second image, e.g. an arrow, to indicate a direction in which it is safe to proceed. Preferably, each image is comprised of a different colour. The nodes 20B are located adjacent doors, e.g. incorporated into the door surround, and are operable between two states, e.g. green or red, to indicate whether or not it is safe to pass through the respective door. Other nodes 20 may take the from of projector units (not shown) mounted on, for example, a wall or ceiling and arranged to project a message or sign onto the floor or another wall or other available surface. The respective light source(s), projector(s) or display(s), or other visual units, may be by physically combined with the node 20 or may be physically separate from the node, in which case the light source can be controlled by the control unit by any convenient means, e.g. a wired or wireless connection. In such cases, the control unit may be provided in any convenient location, e.g. within the fabric of the building.

In the preferred route guidance and evacuation system the intelligence for operating the nodes 20 is distributed amongst the nodes 20 rather than being centralised. This means that if part of the network is destroyed by the very cataclysmic event that triggers the evacuation, the remainder of the network is able to continue to operate and even accommodate the damage.

The control unit of each node 20 comprises a data processing device, e.g. a computer, microcontroller or PLC, that can be programmed to communicate with the rest of the system and control operation of the respective node and/or adjacent node(s) or other node(s) to achieve an overall route guidance or escape strategy.

Advantageously, the nodes 20 are provided with means for communicating wirelessly with one another. However, irrespective of the connection technology, the system provides for uniquely addressable nodes so that the navigation strategy may be correctly tailored to the circumstances that prevail during the fire event.

Typically, the intelligence with which the system is endowed is an embodiment of established rules for building evacuation that are followed by fire officers world-wide, such rules bring programmed into the control unit of each node. These rules respond to the individual building layout therefore when the route guidance and evacuation system is commissioned it should be programmed with key 25 infrastructure information. Nevertheless even at the time of the fire it is possible for a fire officer on site to manually over-ride the automatic navigation instructions if necessary.

The route guidance and evacuation system may comprise part of a primary fire alert system or may be a fully non-invasive adjunct to the primary fire alarm system providing enhanced escape information.

The system may have application completely out with that of providing escape instruction. Even when there is no fire to escape from the route guidance and evacuation system may be used to display advertising, provide night-lighting, or simply provide an interesting route guide for visitors. Accordingly its very familiarity should enhance its effectiveness in the event of a fire with its terrifying circumstances—in that those in need of escape instruction will be acquainted with following its guidance which would not always be the case with conventional primary fire alert beacons.

One purpose of the control module 10 is to allow a human operator to view the operation of the route guidance system, for example as if through a virtual window. To this end, the module 10 comprises a visual display screen 12, e.g. an LCD display, preferably a touch screen that supports user input by touching the screen. The module 10 includes a data processor, conveniently a microprocessor, supporting one or more computer programs to allow the module 10 to support the features described hereinafter, including for example allowing an operator to view images of the building and to monitor and manage the route guidance system, as is described in greater detail hereinafter. The module 10 typically includes, or is configured to support, a user input interface, which may comprise a touch screen interface, a mechanical key pad and/or a mouse as is convenient. The module 10 may also include one or more ports for connection to a peripheral device, such as a mouse or a memory device, or to any one of the nodes 20. The module 10 may also include a wireless communication module (not shown). The module 10 also includes one or more memory device, typically including program memory and RAM. All of the aforesaid are in communication with the microprocessor in normal fashion as would be understood by a skilled person.

In the preferred embodiment, the module 10 allows the operator to view the building on screen as one or more floor plans, and/or even elevations, as applicable. Advantageously, each image displayed on the screen 12 comprises a bitmap image of the floor or other building area being inspected (the term bitmap is intended to embrace pixmap). Conveniently, the images are actual bitmaps of the building's architectural drawings. Each bitmap image may be comprise raw or uncompressed bitmap, or may comprise a compressed bitmap. JPEG and TIF image formats are examples of suitable alternatives to the uncompressed bitmap. More generally, any image having a scale that can be related to the actual dimensions of the relevant building or building part can be used. Typically, there is a source image from which the computer renderable image is created. The source image is a scale version of the actual building, or building part, and the computer renderable image is captured in such a way that scale is preserved (not necessarily 1:1) in the computer renderable image so that, when the image is rendered to a user via screen 12, it is a scale version of the actual building or building part. The source image is conveniently an architectural drawing or other scale drawing (which may be in paper or electronic form), the computer renderable image conveniently comprising a bitmap.

Conveniently, the bitmaps, or other suitable computer renderable image(s) of the building, are generated off-line by any suitable conventional means and stored in any convenient conventional computer-readable file format. The image files may be loaded onto the control module 10 bay any suitable means, e.g. a memory stick or other portable storage device, or by means of a connection to another computing device, e.g. a computing device that supports CAD architectural software or even a scanner.

Because these plans are likely to be larger than can be displayed intelligibly on the screen 12 of the module 10, the module 10 supports means for allowing the viewing window provided by the screen 12 to pan across the image of the plan and preferably also to zoom in and out to adjust the detail on view. There is a known scaling factor between the image and the corresponding building structure so that the image can be used to determine the real world location of items or locations from their position on the image. The displayed image could be scaled to suit the display screen but this can make it difficult to see all of the required items clearly. Preferably, therefore the image has a 1:1, or similar order, scale with the plan drawing from which it was taken.

The control module 10 supports means for allowing icons representing features of the building structure, in particular junctions, but optionally also exits (including doors and/or stairwells), to be superimposed on the image displayed on the screen 12 at a location that corresponds to the respective component's actual location in the building.

The control module 10 supports means for allowing icons representing components of the route guidance system, including the nodes 20 and/or any component associated with, e.g. controlled by, the node (e.g. display, light source, projector etc.), to be superimposed on the image displayed on the screen 12 at a location that corresponds to the respective component's actual location in the building. Each icon is preferably capable of being rendered to the operator in one of a plurality of states depending on one or more characteristics of the corresponding system component. For each state, the appearance of the icon may change, for example the respective icon may be rendered in one of a plurality of different colours and/or different shapes and/or may flash or not. In the example of the floor tile given above, the icon could be coloured green or red and/or could appear as an X or an arrow, depending on the state of the tile node 20A. The characteristics of the components that could affect the state of the respective icon may include its alert status (e.g. alert condition or non-alert condition), the information being conveyed by the component (e.g. the direction of an arrow, the colour of a warning signal, and/or a message being displayed or projected) and/or its operational status (e.g. working or broken). Advantageously, the module 10 is in real-time communication with the route guidance system to receive data indicating the respective characteristics of the relevant components such that the status of the icons is correct and updatable in real-time. Hence, the displayed appearance of the icons is updated in real time to allow the operator to view on the screen 12 the status of the nodes 20 as if walking through the building and looking at the actual display devices of the nodes themselves. Alternatively, or in addition, the module 10 may support means for allowing the operator to select an icon (e.g. by touching it in the preferred embodiment where the screen is a touch screen, but alternatively by clicking on it or hovering over it) in response to which information concerning the corresponding component's status or other characteristics are rendered to the operator.

In the preferred embodiment, the module 10 supports means for allowing icons representing components of the building's hazard detection system, in particular heat detectors and/or smoke detectors, to be superimposed on the image displayed on the screen 12 at a location that corresponds to the respective component's actual location in the building. As described above for the nodes 20, the icons for the hazard detection components may be rendered in one of a plurality of different states (of appearance) depending on the status or other characteristics of the respective component. Alternatively, or in addition, the module 10 may support means for allowing the operator to select an icon (e.g. by clicking on it or hovering over it) in response to which information concerning the corresponding component's status or other characteristics are rendered to the operator. Hence, the operator may learn from the icons what level of hazard it is currently being detected. This provides the operator with more information that would be available during an actual walk-through of the building as it allows the operator to see what the hazard detection system itself “sees” in terms of hazard determination.

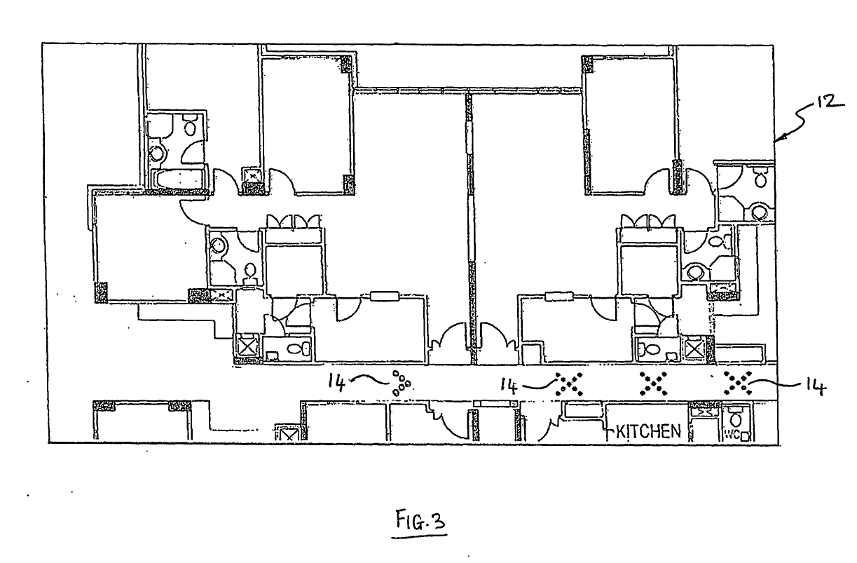

FIG. 3 shows a sample screen shot from screen 12 in which icons 14 are shown representing floor tile type nodes 20.

Advantageously, the module 10 provides an important function in the commissioning phase of the route guidance system. In the preferred embodiment, each of the components, including the nodes 20, of the route guidance system has information indicating the location in the building of every other component, including every other node 20, and preferably also the hazard detectors. This information could be entered manually by typing component coordinates by means of a text console. However, the module 10 supports a more intuitive approach for commissioning by allowing the installer to select a location on the displayed image and drag-and-drop, or place by any other suitable means, an icon representing the required component to that location. Because there is a known scale relationship between the image rendered on the screen (which may be varied by the module 10 to take into account any zoom setting) and the source image from which the computer renderable image was taken, and because there is a known scale relationship between the source image and the actual building, then the operator-selected location of each icon can be correlated to a corresponding location in the building. Once the icons have been located on the displayed floor-plan, the module 10 can communicate, preferably by wireless communication means, the device locations to the relevant system components, including the nodes 20. The module 10 may communicate the device locations (and/or other information, e.g. locations of junctions and/or exits) in any convenient manner, e.g. it may broadcast the information to some or all of the nodes 20, or it may communicate the information to one (or a selected few) nodes from which it can be transmitted through the network from node to node.

The information required for identifying node location may take any suitable form, e.g. 2-dimensional coordinates relative to a reference point on the same floor, or a 3-dimensional coordinate relative to a reference point on, say, the ground floor. In the preferred embodiment, a 2-dimensional co-ordinate relative to a reference point on the relevant floor is used, together with identification of which floor the location is on.

In preferred embodiments, the location information provided to each node enables it to know the absolute position of itself and other nodes with respect to the building, i.e. with a 1:1 scale with reality. This is conveniently achieved by maintaining known scaling factor(s) during processing and scaling these to the real world dimensions when necessary. To this end, the module 10 needs to know (or be able to derive) the scaling factor between the on-screen image and the real world. This may conveniently be achieved by having a single scaling factor between the raw bitmap and the real world (which typically is determined by the scaling factor of the architectural drawing), the module 10 managing all other scaling factors thereafter.

The operator may also place, e.g. by a drag and drop feature supported by the module 10, icons for exits, entries, stairwells and/or other building features. In preferred embodiments, however, the operator and the module are primarily concerned with gateways between zones of the building. Such gateways may be a real world exit/entry or stairwell etc, but typically not all doors are gateways.

Hence, in the first instance the module 10 includes means to support an installer in the job of informing the route guidance system of the locations, e.g. by coordinates, of all corridor or pathway junctions within the building. The software supported by the module 10 does this by permitting the import of, conveniently, raw bitmaps of the building layout and then accepting user input from the touch screen (or other input means, e.g. keyboard and/or mouse) to indicate junction coordinates (and also the location of nodes 20 and hazard sensor devices) by placement of respective icons on the displayed image. The control module software automatically converts the position on the displayed image to a corresponding coordinate position within the building.

During normal use, the operator does not use the control module 10 to control the behaviour of the nodes 20 of the route guidance system. Instead, the nodes 20 are programmed to implement an exit algorithm in response to detected hazards, the module 10 providing a remote “window” to allow the operator to inspect the exit routes being selected by the route guidance system. A role of the control module 10 here is to inform the operator, e.g. an emergency supervisor (such as a fire chief) of the real time status of the emergency. The control module 10 receives the real-time hazard information from the hazard detection system via any suitable communications link, e.g. a USB connection, or wireless or Ethernet link, at the same time as the system nodes 20 receive it, and the module 10 can therefore display the hazard information in real time on the screen 12 for the supervisor to evaluate. At the same time, the control module 10 receives the route information from the route guidance system. Conveniently, the module 10 obtains this information by communicating with a single node (typically the nearest node) by any suitable means e.g. wirelessly or by a wired e.g. USB, connection. The module 10 is therefore able to display the routes that have been automatically selected by the system to permit the supervisor to judge if this is sensible. Displaying the routes is achieved by setting the displayed characteristics of the relevant icons on the screen.

However, the module 10 allows the operator to manually over-ride the settings of the nodes 20 in the event that it is desired to direct people in an alternative direction, for example because of new information available to the operator or because the emergency services need to isolate part of the building.

Accordingly the control module 10 permits the operator to manually over-ride certain features of the route guidance system and, optionally, of the building's hazard control system. A convenient way to allow the operator to alter the node 20 settings is to allow the operator to set the status of the hazard detectors, e.g. to select between a “hazard detected” state or a “no hazard detected” state, or between more than two hazard level states if supported by the hazard detectors. This can be achieved via the respective icon corresponding to the relevant hazard detector. Because the preferred exit algorithm makes its decisions based on detected hazard levels, this manual adjustment will have a direct impact on the exit routes offered by the route guidance system. It is preferred that the module 10 also allows the operator to manually set the characteristics, e.g. the displayed message, arrow direction and/or colour, of any of the nodes 20 irrespective of the measured hazard level.

To this end the control module 10 supports means for maintaining one or more operator settable properties in respect of each component (e.g. nodes 20 and/or hazard detectors) and for allowing the operator to set each property to a selected one of a plurality of property values. The properties and selectable property values may vary from component to component. Conveniently, the user selects a component by means of the respective displayed icon, in response to which the module 10 provides the operator with access to the respective selectable properties. The operator can set the property values by any suitable input means, e.g. keypad or touch screen. Once the operator has set the property values, the values are communicated to the respective system components, which configure themselves in accordance with the received property values. For example, in the case of a node 20, this may involve projecting a particular message, illuminating in a particular colour and/or presenting an arrow in a particular direction. In the case of a hazard detector, this may involve issuing an audio and/or visual alarm, and/or issuing a corresponding signal to the route guidance system.

The affect of the over-ride messages provided by the module 10 can be designated either as temporary or permanent—if they are temporary then they will only survive until the next system routine update when the property data will be replaced with the true data. If they are to be permanent then one or more flags (as required) may be set in the route guidance system and/or in the hazard detection system, as applicable, to inhibit the true data from replacing the manual setting so that the manual settings will remain in place until the operator changes them or clears the over-ride flag(s). The over-ride flags are conveniently supported by the module 10, which allows the operator to set the flag(s) after which the flag setting are communicated to the system(s).

In cases where the route guidance system includes means for detecting people in the building, e.g. comprising a transponder system, such as an RFID system or other radio transponder system, then the control module 10 may be arranged to permit the operator to search the building for a given first-responder (e.g. an individual from the emergency services) and locate them on the floor-plan (e.g. with a respective icon displayed on the screen 12), optionally together with a complete history of their movements to date during the emergency. Hence, the module 10 allows the operator to track individual “first responders” as they move through the building. This permits an emergency supervisor to track emergency workers through the building, to search for individuals and locate them within the building, and to trigger automatic alarms if parameters are exceeded such as time spent by a given individual within a hazardous area, or immobility or isolation of a given individual. To this end, each node 20 in the route guidance system may be equipped with a detector, e.g. an RF receiver, and each of the people to be tracked are provided with a co-operable transponder unit, e.g. an RFID tag, with a unique ID. When a node 20 detects a tag, it broadcasts the ID of the detected tag along with its own coordinate location throughout the network so that it can be picked up and read by the control module 10. This permits the control module 10 to display the location of any tag (and hence its wearer).

For nodes 20 that include means for displaying messages, e.g. by a projector or screen, the module 10 may support the creation of messages by the operator and the transmission of such messages to the respective node(s) 20 for rendering to people in the building.

The preferred exit algorithm supported by the nodes 20 for helping people navigate their way out of a building in an emergency depends on a systematic knowledge of the building layout. The algorithm itself does not run on the module 10, but the module 10 is key to providing this knowledge to the system hardware (including the nodes 20) where the algorithm operates. The preferred algorithm addresses some key challenges, in particular being immune to partial destruction of the building and being able to automatically determine a preferred exit route based on real-time updates of risk measures within the building.

Preferably, the algorithm comprises first and second distinct phases—a one-time setup phase and a continuously updated real-time phase. During the setup phase the system, including the nodes 20, is provided with the coordinates of all junctions within the building and it uses this data to calculate automatically all possible routes out of the building. To do this does the system needs to know where the exits are, and this information will typically have been provided to the module by the operator by appropriate addition of icons onto the display screen. During the real-time phase the system ranks all possible routes in order of preference (based on, typically, a combined measure of hazard and distance). In the preferred embodiment, these calculations are performed by each of the nodes 20.

A benefit of the preferred approach is that there is no master controller anywhere in the building. All nodes in the building run identical software, they are all knowledgeable of the entire route structure, they all make identical decisions based on identical logic about the preferred exit route(s), and if any one or more nodes are destroyed by incident during the emergency this in no way hinders the remaining nodes from continuing to operate.

In support of the foregoing, preferred embodiments of the control module 10 support software that allows an installer to attach a number of “objects”, by means if the icons referred to above, onto the displayed bitmap that have interactive properties (for example like hypertext on a website). This means that a subsequent user, e.g. the operator mentioned above, can then select, e.g. by touching, on these objects to learn about their status or to change their status. Also, the “status” of these objects is in fact the real status of the physical device in the building that the screen icon represents—such as a sensor or a directional indicator (node 20).

The preferred control module 10 allows the installer to “drag and drop” objects in the preferred form of icons onto the displayed image. As well as the objects for nodes 20, hazard detectors and junctions, the preferred embodiment supports the creation of an origin object, or icon, that serves as a co-ordinate origin for the other icons. Once the origin icon is placed by the user, the control module 10 is able to automatically generate coordinate locations for the devices in the building that are represented by icons on the screen 12. This is particularly useful in the case where the control module 10 is being used to track the movement of people within the building, e.g. emergency first-responders since their actual location in the building can be relayed to the control module 10 and displayed appropriately on the displayed image by means of the known scale relationship.

In preferred embodiments, the coordinate information created by the control module is defined relative to the origin icon placed by the operator on the screen 12. In other words, location is not defined in terms of GPS coordinates but rather in distances from the origin of the building.

In preferred embodiments, the control module supports computer software having one or more of the following features: means for displaying a floor plan bitmap; means for causing the display to be switchable between multiple floor plan bitmaps; means for zooming in and out on the displayed image; means for panning across he displayed image; means for overlaying locations of detectors and/or nodes and/or junctions as icons; means for defining an on screen location origin; means for dragging and dropping icons on screen; means for associating junctions with segments; means for defining a gateway junction function; means for associating gateways with adjacent zones; means for confirming coordinates; means for allowing manual entry of coordinates; means responsive to icon selection to open dialog box with status data; means for supporting detector status data comprising hazard type, hazard level, address and over-ride flag; means for supporting node status data comprising direction (if applicable), colour (if applicable), address and over-ride flag; means for real-time updating of displayed icons; means for allowing manual over-ride of status data; over-ride function to manually set the hazard level for any sensor; over-ride function to manually set the colour for any segment; over-ride function to manually set the direction for any segment; means for communicating with route guidance system and/or hazard detection system.

The invention is not limited to the embodiment described herein, which may be modified or varied without departing from the scope of the invention.

1. A route guidance system for guiding occupants of an enclosed space to a location, such as an exit, said system comprising:
a network of nodes located at spaced locations throughout an enclosed space, at least some of said nodes being operable to cause a route guidance instruction to be conveyed to one or more occupants of the enclosed space, each node comprising a control unit and a communication device enabling said control unit to communicate with a control unit of at least one other nod; for passing information between adjacent ones of said nodes;
a control module comprising a display screen;
a storage device operable to store an image representing the enclosed space,
wherein said control module is operable to display said image representing the enclosed space on said display screen as a scale representation of the enclosed space;
wherein said control module is operable to enable a user to locate at least one computer generated icon on said image representing the enclosed space that is displayed at said display screen;
wherein said control module is operable to calculate, in respect of a location of said at least one icon on said image representing the enclosed space that is displayed at said display screen, and a corresponding location in the enclosed space; and
wherein said control module is operable to communicate data representing the corresponding location in the enclosed space to at least one of said nodes.

2. A route guidance system as claimed in claim 1, wherein said control module is operable to display a user location on said displayed image of computer generated icons, said computer generated icons representing one or more of (i) a component of said route guidance system (ii) a component of the enclosed space, and (iii) a component of a hazard detection system.

3. A route guidance system as claimed in claim 2, wherein, using said data communicated by said control module, each node is arranged to maintain an electronic representation of the enclosed space including the respective locations of at least some components of said route guidance system and also the respective locations of at least some components of a hazard detection system.

4. A route guidance system as claimed in claim 2, wherein, using said data communicated by said control module, each node is arranged to determine its position in the enclosed space or the respective position of a route guidance device associated with said node.

5. A route guidance system as claimed in claim 2, wherein, using said data communicated by said control module, each node is arranged to determine the position of at least one chosen from (i) at least one other of said nodes in the enclosed space, and (ii) the respective positions of all others of said nodes.

6. A route guidance system as claimed in claim 2, wherein, using said data communicated by said control module, each of said nodes is arranged to determine which others of said nodes are adjacent to itself in the enclosed space.

7. A route guidance system as claimed in claim 1, wherein said image comprises a bitmap of a source image of the enclosed space.

8. A route guidance system as claimed in claim 7, wherein said source image comprises a building plan drawing of the enclosed space.

9. A route guidance system as claimed in claim 8, wherein said control module is arranged to display a 1:1 scale image of said building plan drawing.

10. A route guidance system as claimed in claim 1, wherein said control module is arranged to support at least one chosen from panning and zooming in respect of said displayed image.

11. A route guidance system as claimed in claim 2, wherein each of said computer generated icons, or its respective associated component, is assigned a unique identifier.

12. A route guidance system as claimed in claim 11, wherein said unique identifier identifies the respective component and also the type of component.

13. A route guidance system as claimed in claim 1, wherein at least one chosen from said enclosed space and said location is defined by co-ordinate data calculated with respect to a co-ordinate origin.

14. A route guidance system as claimed in claim 1, wherein said at least one icon comprises a plurality of icons, and wherein at least some of said icons are renderable in a plurality of visual states.

15. A route guidance system as claimed in claim 14, wherein said control module is arranged to receive from said route guidance system, or from a hazard detection system with which said route guidance system is associated, status data indicating the status of one or more components represented by said at least one icon displayed on said screen, said control module being arranged to cause said at least one icon to adopt one of said plurality of visual states depending on said status data.

16. A route guidance system as claimed in claim 15, wherein said control module is arranged to maintain, in respect of at least some of said components in respect of which said at least one icon is displayed on said screen, one or more user-settable parameter settings, wherein in response to the user setting one of said parameter settings, said control module is arranged to communicate said parameter setting to at least one of said nodes.

17. A route guidance system as claimed in claim 16, wherein in response to receiving one of said parameter settings indicating a desired status of one of said components, a respective one of said nodes is arranged to (i) adopt said desired status, or (ii) cause the respective associated route guidance device to adopt said desired status.

18. A route guidance system as claimed in claim 16, wherein said control module is arranged to expose a respective one of said parameter settings to the user upon selection by the user of a corresponding one of said at least one icon.

19. A route guidance system as claimed in claim 1, wherein said control module comprises a portable unit that is capable of communicating with said nodes remotely.

20. A control module for a route guidance system for guiding occupants of an enclosed space to a location, such as an exit, said system comprising a network of nodes located at spaced locations throughout the enclosed space, at least some of the nodes being operable to cause a route guidance instruction to be conveyed to the occupants of the enclosed space, each node comprising a control unit and a communication device enabling the control unit to communicate with a control unit of at least one other node, for passing information between adjacent ones of said nodes; said control module comprising:
a display screen,
a storage device operable to store an image representing the enclosed space;
wherein said control module is operable to display said image representing the enclosed space on said display screen as a scale representation of the enclosed space; and
wherein said control module is operable to enable a user to locate at least one computer generated icon on said displayed image representing the enclosed space that is displayed at said display screen;
wherein said control module is operable to calculate, in respect of a location of said at least one computer generated icon on said image representing the enclosed space on said display screen, a corresponding location in the enclosed space; and
wherein said control module is operable to communicate data representing the corresponding enclosed space location to at least one of said nodes.

21. A method of managing a route guidance system using a control module, said method comprising;
displaying at a control module a scale image of an enclosed space;
locating one or more computer-generated icons on the displayed image;
calculating, in respect of a location of the at least one computer-generated icon on the displayed scale image, a corresponding location in the enclosed space; and
communicating data representing the corresponding location in the enclosed space to at least one node in a network of nodes located at spaced locations throughout the enclosed space.
